(19) United States
(12) Patent Application Publication
(10) Pub. No.: US 2015/0285001 A1
(43) Pub. Date: Oct. 8, 2015

(54) Paint bucket step ladder hook with design handle

(71) Applicants: Stephen Albert Bardill, Sterling Heights, MI (US); Vito Monteleone, Sterling Heights, MI (US)

(72) Inventors: Stephen Albert Bardill, Sterling Heights, MI (US); Vito Monteleone, Sterling Heights, MI (US)

(21) Appl. No.: 13/999,892

(22) Filed: Apr. 2, 2014

(51) Int. Cl. E06C 7/14

(52) U.S. Cl. CPC E06C 7/14

(57) ABSTRACT

A step ladder step hook (110) and 45 degree offset horizontal frame (112) intersect to create an embodiment for a vertical thumb rest (114) and vertical handle (116). This handle makes it faster, safer, and easy for a user to move a can of paint or utility bucket from step to step on a step ladder. Left- or right-handed painters can maneuver their can of paint or utility bucket with our unique easy to grip handle. A lower vertical hook (118) will easily hook to a can of paint or utility bucket. The step ladder hook (110) will simply be hung to the step ladder step through the easy to grip handle.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a paint bucket hook for attaching a can of paint, or a utility bucket securely to a step ladder.

2. Prior Art

Not Applicable

### OBJECTS AND ADVANTAGES

Several objects and advantages of the present invention are:
(a) To provide a paint bucket step ladder hook with design handle.
(b) To provide a paint bucket step ladder hook for a step ladder for right- and left-handed painters.
(c) To provide a faster way for the painter or homeowner to move the can of paint, or utility bucket from step to step on a step ladder, as a single unit while the paint can or utility bucket is securely attached to the step ladder hook. This includes moving the can of paint or utility bucket vertical up and vertical down the step of the step ladder.
(d) To provide a safer and easier way for the painter, or homeowner to maneuver the paint can or utility bucket from horizontal left on the step of the step ladder to horizontal right on the step of the step ladder.
(e) To provide an easy-to-grip handle so the painter, or homeowner can move the can of paint or utility bucket from step to step on a step ladder using only one hand.
(f) To provide a strong, secure step ladder hook and handle.
(g) To provide a simple lightweight design for greater maneuverability.
(h) To provide convenient paint can access so the painter or homeowner can improve production.

Further objects and advantages of the invention will become apparent from a consideration of the drawings and ensuing description.

### SUMMARY

In accordance with the present invention, the primary object is to provide tradesmen and homeowners a fast and safe way to move the can of paint or utility bucket from step to step on a step ladder. This task can be accomplished by using our step ladder bucket hook. The tradesmen or homeowner simply attaches the utility bucket handle or paint bucket handle to the lower vertical hook, then grips the handle and attaches the can of paint or utility bucket securely to the step of the step ladder through means of the upper horizontal hook.

### DRAWINGS

### Figures

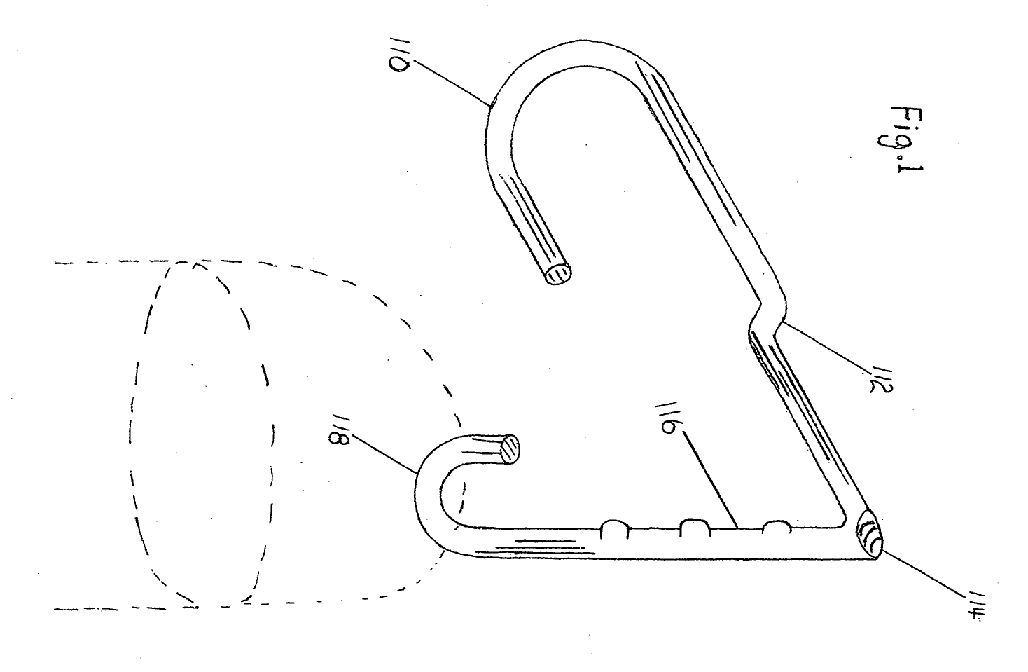

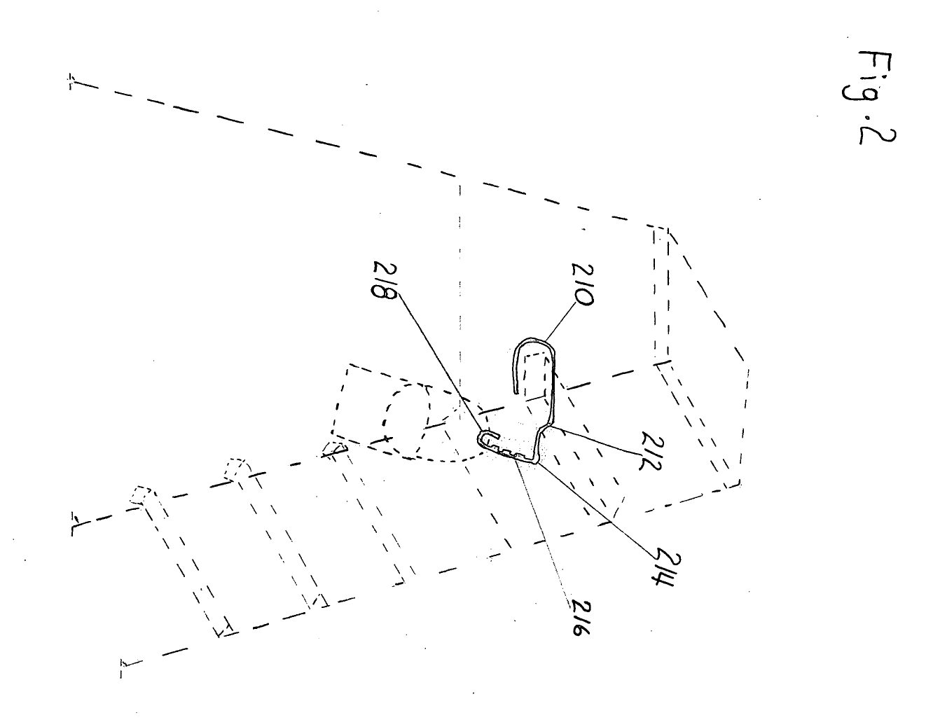

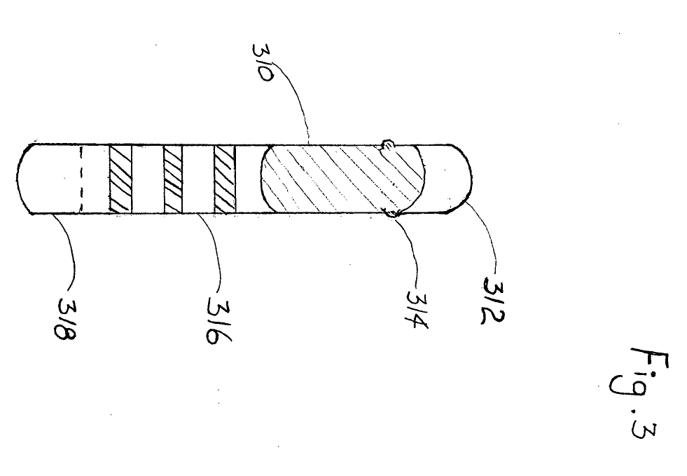

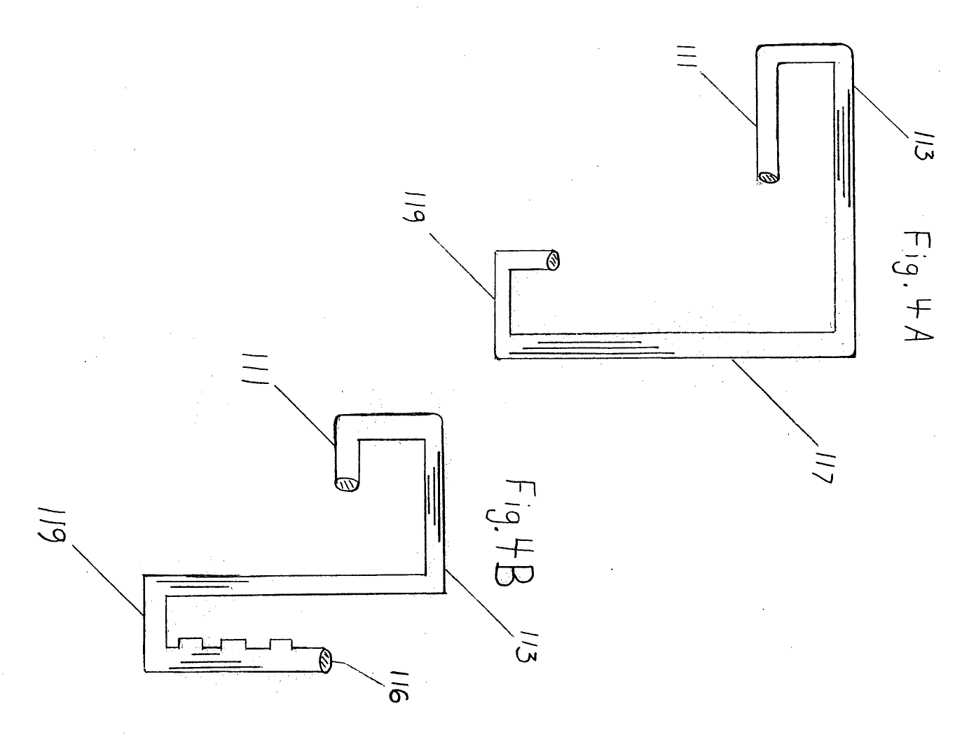

FIG. 1 is an isometric view of the step ladder bucket hook with vertical grip design handle.

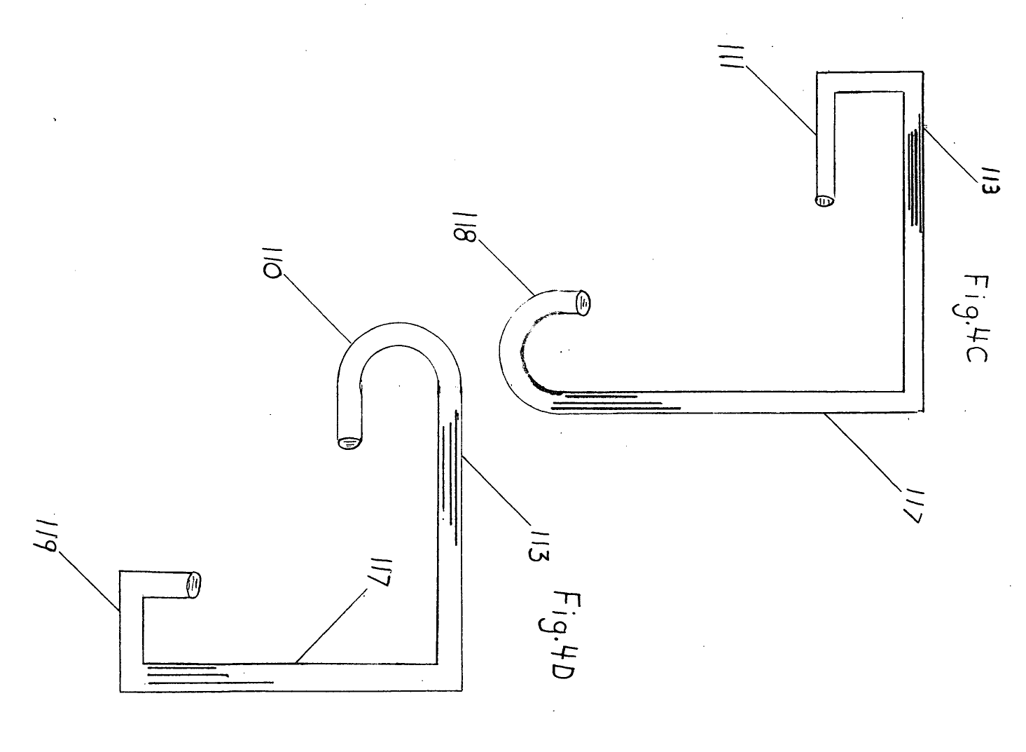

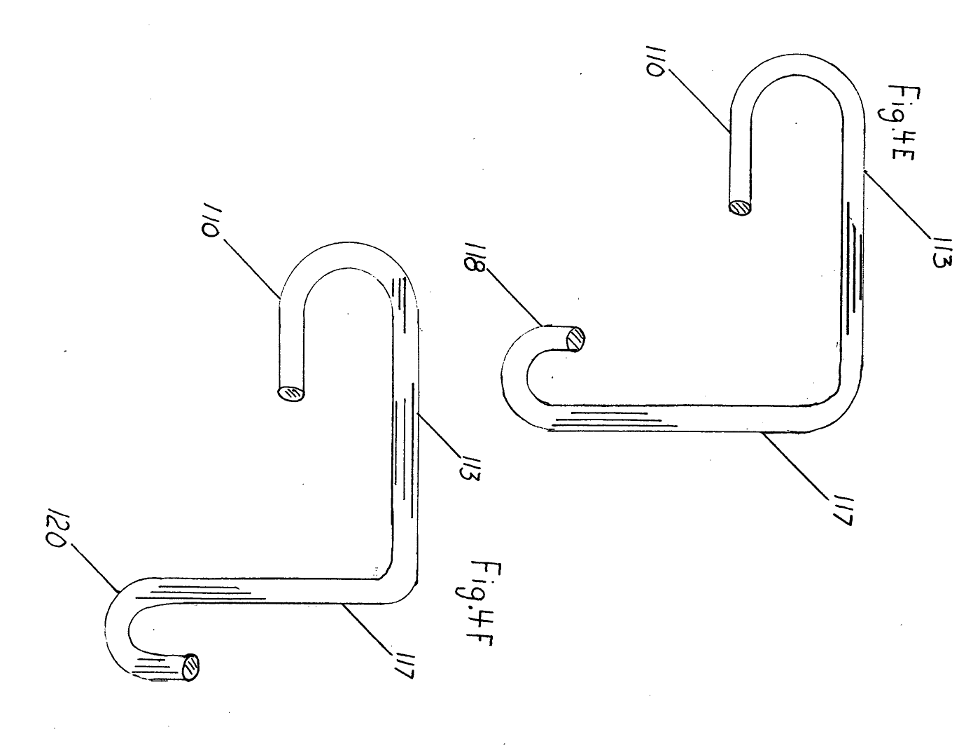

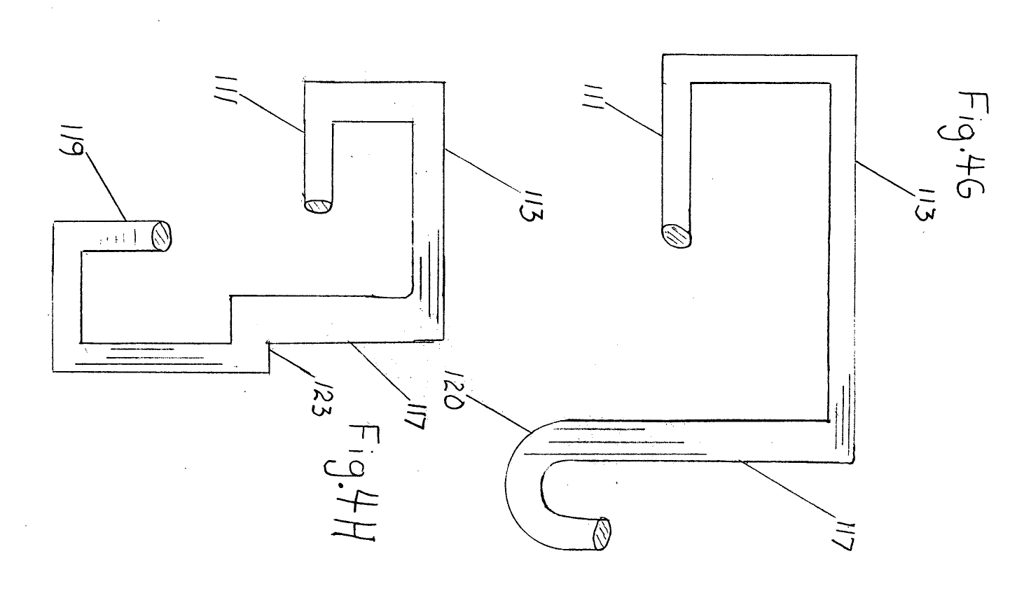

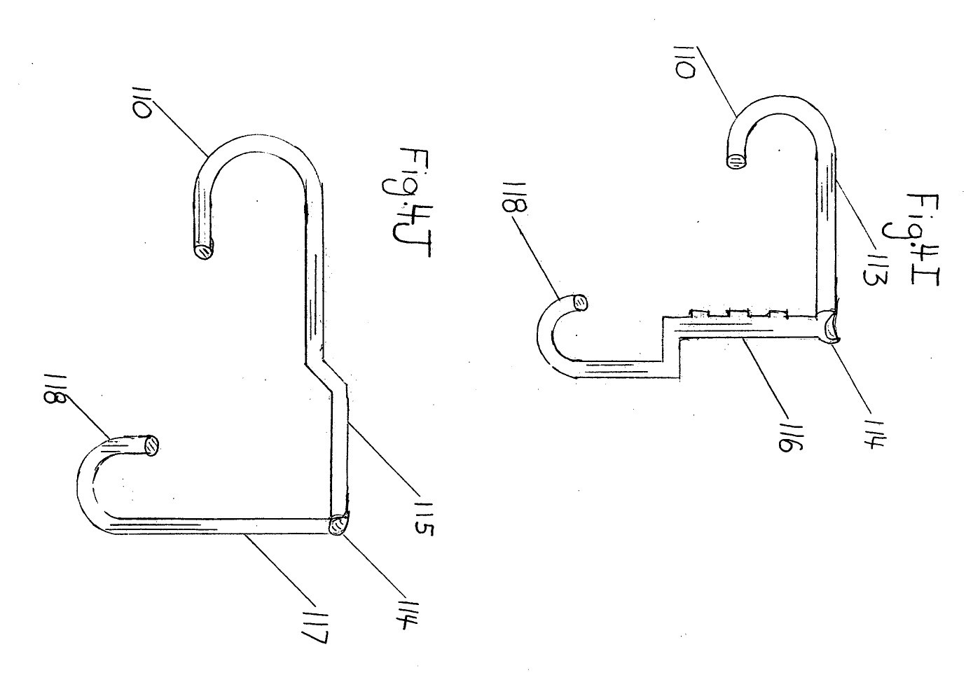

FIG. 2 is a left side view of the step ladder bucket hook securely attached to a step ladder step, with the can of paint or utility bucket securely attached to the lower vertical hook.

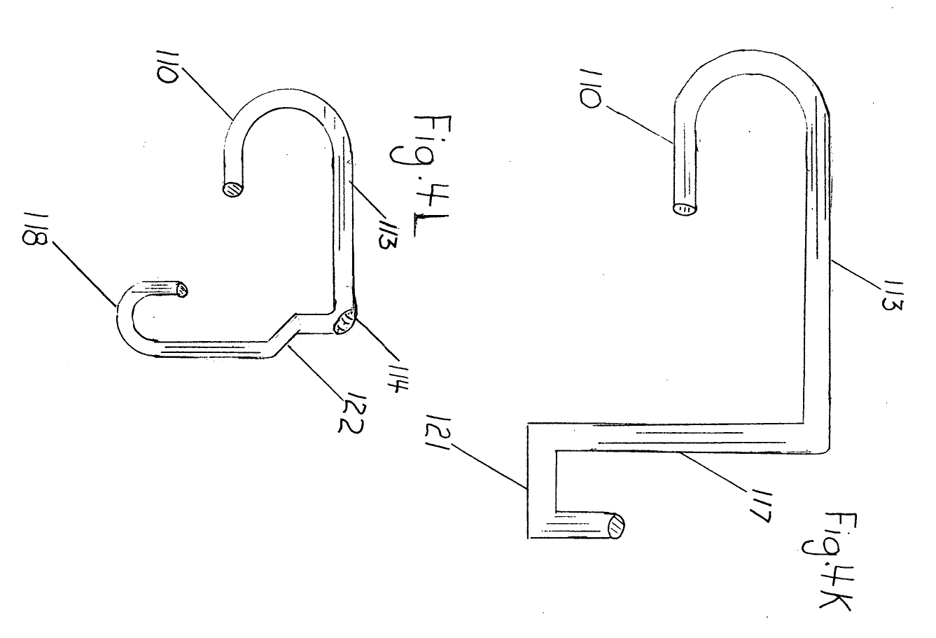

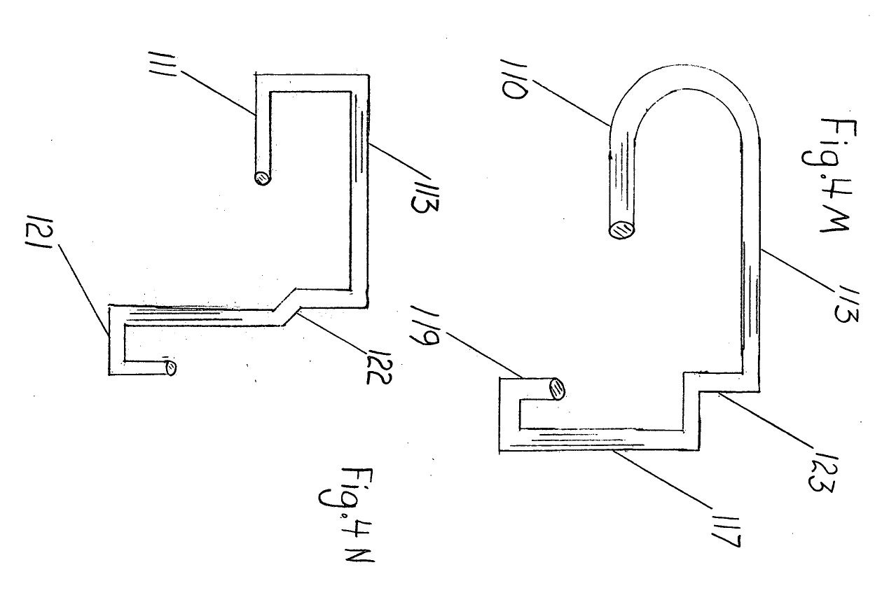

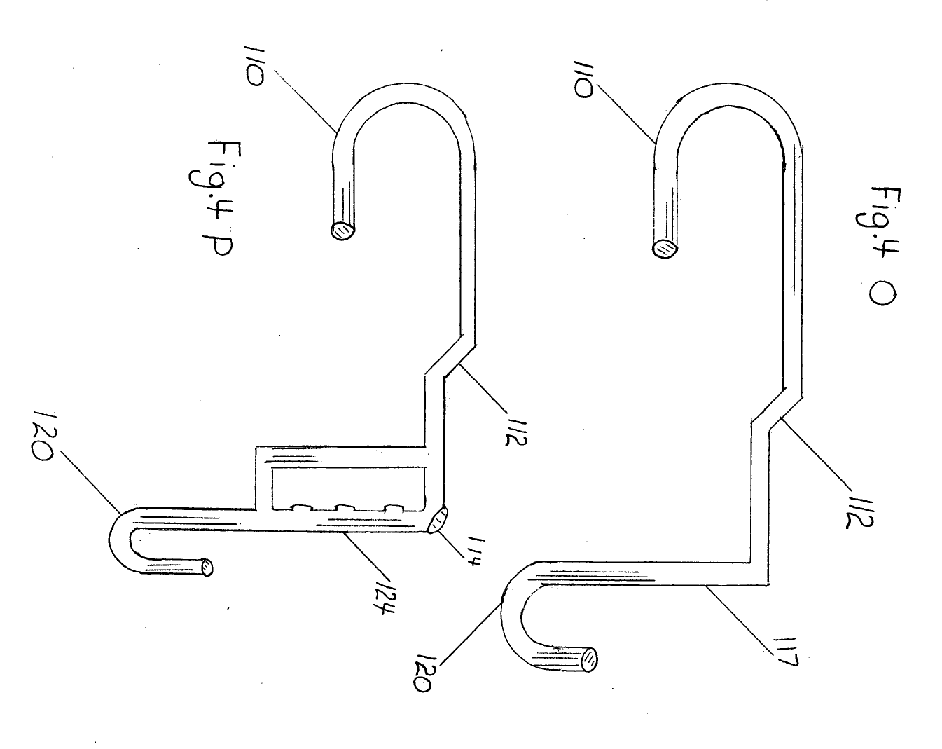

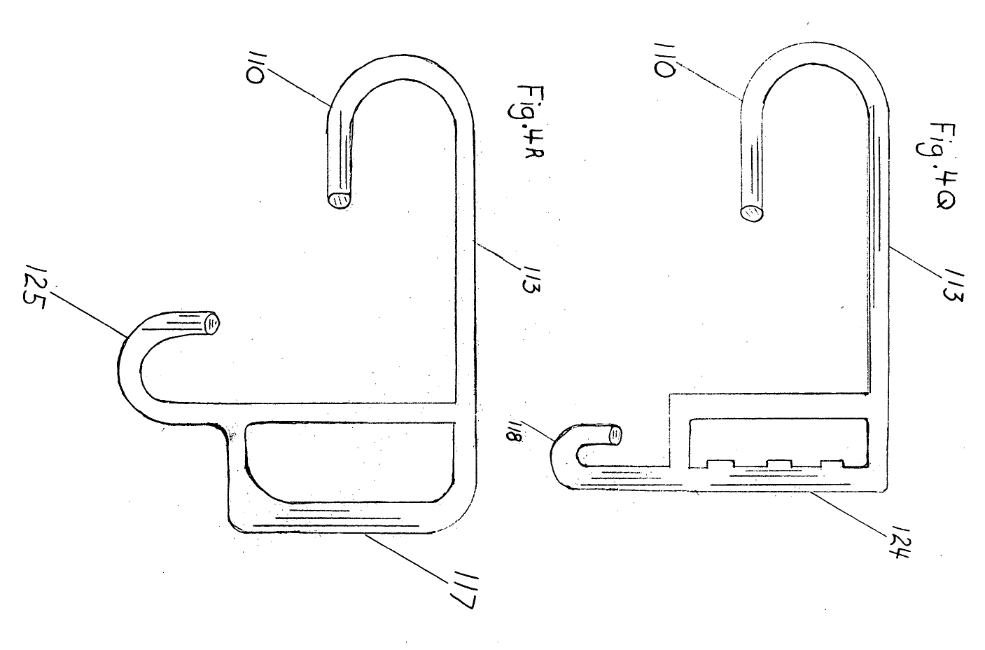

FIG. 3 is a front view of the step ladder bucket hook with vertical grip handle.

The broken line showing the paint bucket in FIG. 1 and FIG. 2 is for illustrative purposes only and forms no part of the claimed design. Moreover, the broken line in FIG. 2 showing the side of the step ladder rail and step are for illustrative purposes only.

### REFERENCE NUMERALS

110, 210 and 310 upper horizontal hook
111 upper horizontal rectangular hook
112, 212 and 312 45 degree offset horizontal frame
113 horizontal frame
114, 214 and 314 vertical thumb rest
115 45 degree offset upper horizontal frame
116, 216 and 316 vertical design grip handle
117 vertical design handle
118, 218 and 318 lower vertical hook
119 rectangular lower vertical hook
120 lower reversed design vertical hook
121 lower reversed rectangular vertical hook
122 45 degree offset vertical design handle
123 90 degree horizontal frame
124 vertical closed grip design handle
125 left side mount lower vertical hook
126 left side mount lower rectangular vertical hook
127 rectangular cradle

### DETAILED DESCRIPTION

### Preferred Embodiment

The drawings and especially FIG. 1 show the following: a step ladder bucket hook with vertical design grip handle for moving the paint can or utility bucket quickly from step to step on a step ladder. Constructed in accordance with the invention, a strong plastic is formed in the shape of a hook with a built-in handle. FIG. 1 shown has a rounded step ladder step hook 110 connected to the 45 degree offset horizontal frame 112. 45 degree offset horizontal frame 112 also connects to vertical thumb rest 114. Vertical thumb rest 114 also connects to vertical design grip handle 116. Vertical design grip handle 116 also connects to lower vertical hook 118.

### OPERATION

### Preferred Embodiment

FIGS. 1, 2 and 3 will illustrate the intended use and operation of the step ladder bucket hook with vertical design grip handle. FIG. 1 illustrates the rounded step ladder step hook 110. This hook is designed to hang easily and securely to a step of a step ladder. 45 degree offset horizontal frame 112 and vertical design grip handle 116 are both connected to give the user an easy-to-grip fast-action handle for maneuvering the bucket from step ladder step to step on a step ladder. Lower vertical bucket hook 118 connects to vertical design grip handle 116 to complete the handle. The user can attach a can of paint, or utility bucket to the lower vertical hook 118. This will create a one-piece unit for the user. The user can now move the can of paint, or utility bucket fast and efficient from step ladder step to step on a step ladder in a safe and secure manner.

FIG. 2 illustrates a side view of the rounded step ladder step hook 110. Vertical design grip handle 116 connects to vertical thumb rest 114 and 45 degree offset horizontal frame 112 and also lower vertical hook 118. A full can of paint or utility bucket will be securely attached to lower vertical hook 118 through the can of paint or utility buckets wire handle.

FIG. 2 show broken lines replicating a step ladder, with the can of paint securely attached onto.

FIG. 2 also shows the can of paint securely attached to lower vertical hook 118. Therefore, giving the painter or homeowner; a single unit to move quickly and efficiently from step to step on a step ladder.

FIG. 2 also illustrates the vertical design grip handle for hand-held gripping, for left or right-handed painters enabling workers to move the can of paint, or utility bucket fast and efficiently from step to step on a step ladder.

FIG. 3 illustrates the front view.

### BRIEF DESCRIPTION OF DRAWINGS

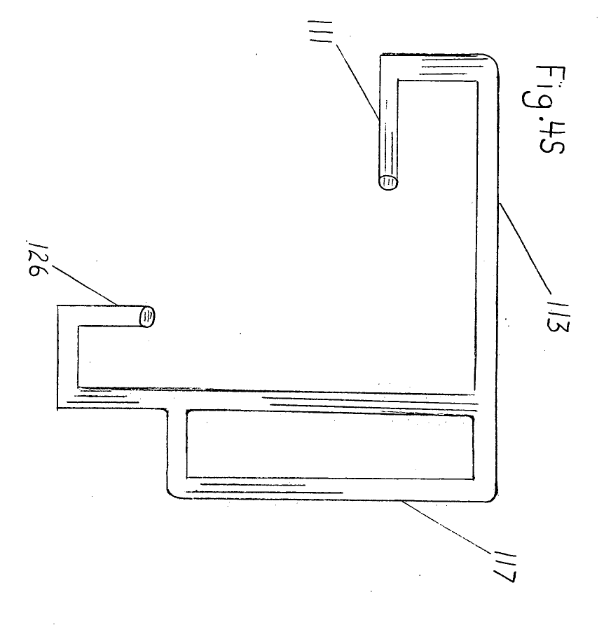

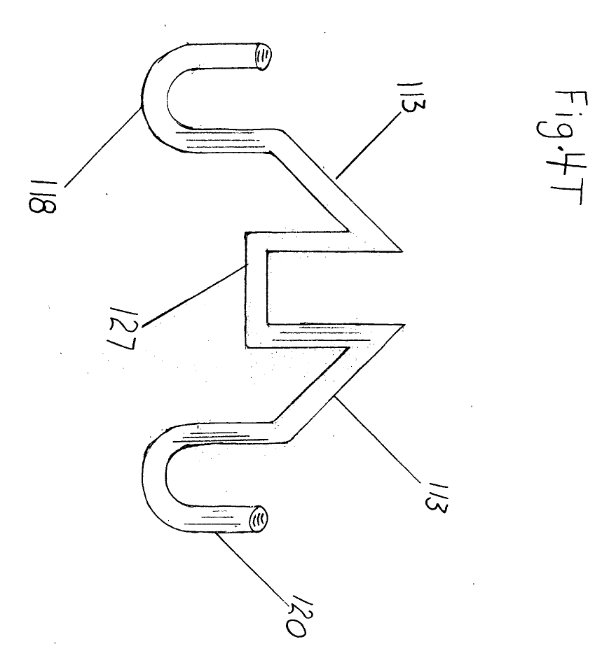

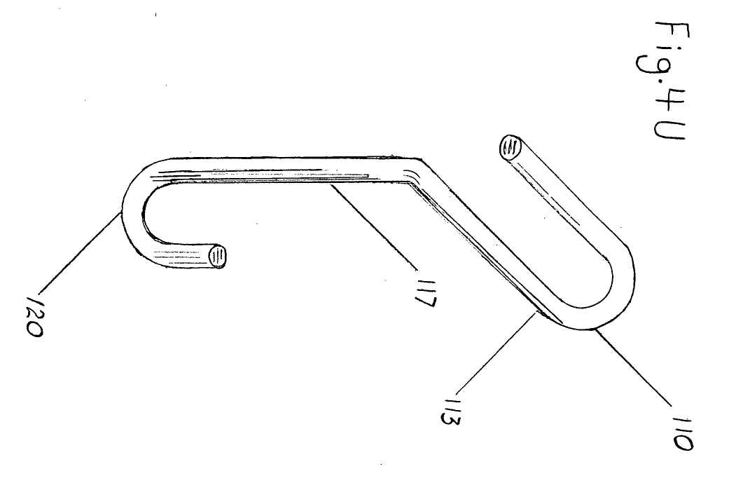

There are various alternative embodiments and configurations for the present invention. These alternative embodiments are listed as FIG. 4A through FIG. 4U.

FIG. 4A is a design of an upper horizontal rectangular hook with a vertical design handle, and a rectangular lower vertical hook.

FIG. 4B shows a bottom mounted vertical design grip handle with a rectangular lower vertical hook, and an upper horizontal rectangular hook.

FIG. 4C illustrates an upper horizontal rectangular hook with a vertical design handle, and a lower vertical hook.

FIG. 4D shows an upper horizontal hook with a vertical design handle, and a lower rectangular vertical hook.

FIG. 4E is a design of an upper horizontal hook with a vertical design handle, and a lower vertical hook.

FIG. 4F illustrates an upper horizontal frame with a vertical design handle, and a lower reversed design vertical hook.

FIG. 4G shows an upper horizontal rectangular hook with a vertical design handle, and a lower reversed design vertical hook.

FIG. 4H displays an upper horizontal rectangular hook with a vertical design handle, and rectangular lower vertical hook.

FIG. 4I illustrates an upper horizontal hook with a vertical design handle, and a lower vertical hook. This also displays a vertical thumb rest.

FIG. 4J displays an upper horizontal hook with a 45 degree offset horizontal frame, and a vertical design grip handle with lower vertical hook.

FIG. 4K shows an upper horizontal hook with a vertical design handle, and a lower reversed rectangular vertical hook.

FIG. 4L displays an upper horizontal hook with a 45 degree offset vertical design handle, and a lower vertical hook.

FIG. 4M shows an upper horizontal hook with a 90 degree horizontal frame, and a rectangular lower vertical hook.

FIG. 4N illustrates an upper horizontal rectangular hook with a 90 degree horizontal frame, and a lower reversed rectangular vertical hook.

FIG. 4O displays an upper horizontal hook with a 45 degree offset horizontal frame, and a lower reversed design vertical hook.

FIG. 4P illustrates an upper horizontal hook with a 45 degree offset horizontal frame, and a vertical closed grip design handle with thumb rest, and a lower reversed design vertical hook.

FIG. 4Q shows an upper horizontal hook, and a horizontal frame with vertical closed grip design handle, and a lower vertical hook.

FIG. 4R displays an upper horizontal hook, and a horizontal frame with a vertical design handle, and a left side mount lower vertical hook.

FIG. 4S illustrates an upper horizontal rectangular hook with a vertical design handle, and a left side mount lower rectangular vertical hook.

FIG. 4T shows an upper horizontal frame with a rectangular cradle, and a lower vertical hook, and a lower reversed vertical hook.

FIG. 4U displays an upper horizontal hook, and a lower reversed design vertical hook.

FIG. 4A is a side view of the step bucket ladder hook with an alternative straight vertical shaped handle. This handle is simple to grasp for right- or left-handed painters. This design has great maneuverability from step to step on a step ladder.

FIG. 4B is a side view of the step ladder bucket hook with an alternative bottom mounted grip handle. This bottom mounted handle is easy to grasp for left- or right-handed painters. This design will make it easy for the painter or homeowner to move the can of paint, or utility bucket from step to step on a step ladder.

FIG. 4C is a side view of the step ladder bucket hook with an alternative rectangular upper horizontal hook and lower vertical hook. This design gives the worker a well-balanced handle for better productivity moving the can of paint or utility bucket from step to step on a step ladder.

FIG. 4D is a side view of the step ladder bucket hook with an upper horizontal hook with a vertical design handle. This design is lightweight, easy to use and holds the can of paint or utility bucket securely to the lower rectangular vertical hook.

FIG. 4E is a side view of the step ladder bucket hook with an alternative horizontal frame. This design makes it safe and fast moving the can of paint or utility bucket up and down the step ladder step. Right- or left-handed people can grasp the handle very easily.

FIG. 4F is a side view of the step ladder bucket hook with an alternative lower reversed design vertical hook. This design allows the homeowner to attach a bucket quickly to the lower reversed vertical hook.

FIG. 4G is a side view of the step ladder bucket hook with an alternative lower reversed design vertical hook. This design gives the user easy access to attach a bucket to the step ladder bucket hook.

FIG. 4H is a side view of the step ladder bucket hook with an alternative style design handle. This design gives the user better balance with the bucket.

FIG. 4I is a side view of the step ladder bucket hook with an alternative style design handle. This design will increase productivity and ease of use, by means of the design grip handle with thumb rest.

FIG. 4J is a side view of the step ladder bucket hook with a 45 degree offset upper horizontal frame. This design is for right- or left-handed users.

FIG. 4K is a side view of the step ladder bucket hook with a lower reversed rectangular vertical hook. This design will increase safety.

FIG. 4L is a side view of the step ladder bucket hook with a 45 degree offset vertical design handle. This design has a contoured thumb rest.

FIG. 4M is a side view of the step ladder bucket hook with an alternative 90 degree horizontal frame. This design gives the user greater stability on the step ladder.

FIG. 4N is a side view of the step ladder bucket hook with an alternative 45 degree offset vertical design handle. This design gives the worker easier movement up and down the step ladder.

FIG. 4O is a side view of the step ladder bucket hook with an alternative 45 degree offset horizontal frame. This design benefits in moving the bucket safely and easily on the step ladder.

FIG. 4P is a side view of the step ladder bucket hook with an alternative vertical closed grip design handle. This design gives the user better stability using a 5 gallon bucket on the step ladder.

FIG. 4Q is a side view of the step ladder bucket hook with an alternative horizontal frame and a vertical closed grip design handle. This design gives the user easy movement with the bucket from step to step on the step ladder.

FIG. 4R is a side view of the step ladder bucket hook with an alternative left side mount lower vertical hook. This design is safer and quicker for the user to grip and move the paint can from step to step, up or down on a step ladder.

FIG. 4S is a side view of the step ladder bucket hook with an alternative upper horizontal rectangular hook, and a left side mount lower rectangular vertical hook. This design is for moving various size buckets either left- or right-side of the step ladder rail.

FIG. 4T is a front view of the step ladder bucket hook with an alternative rectangular cradle with left- and right-side vertical hooks. This design allows the user to use two buckets on the step ladder.

FIG. 4U is an isometric view of the step ladder bucket hook. This design attaches to left- or right-side of the step ladder side rails.

### Advantages

From the description above, a number of advantages of our present invention are evident:
(a) The painter can very quickly move the step ladder bucket hook with the can of paint or utility bucket attached to it as a single unit.
(b) The user can safely transport the step ladder bucket hook as a single unit to the desired position on a step ladder with one hand.
(c) As the work progresses, the user can very easily and quickly reposition the paint can or utility bucket on either side of a step ladder, left or right side of the step.
(d) As the painting progresses, the painter can move the paint can or utility bucket up or down the step of the step ladder in a fast and safe manner.
(e) The user can be a right- or left-handed person.
(f) The step ladder bucket hook is simple and lightweight for ease of use.
(g) The step ladder bucket hook can be economically manufactured in quantities.
(h) The step ladder bucket hook makes a worker's job faster, safer, easier and increases their paint production by saving time, through its quick grip handle.
(i) The user now has an easy way to attach a bucket to a step ladder.
(j) The user can attach a 5 gallon bucket to the step ladder bucket hook and paint with a paint roller.
(k) The user can also attach an empty 5 gallon bucket to the step ladder bucket hook for gutter cleaning, window washing, fruit picking and carrying tools.
(l) The homeowner can achieve better balance through means of the 45 degree offset vertical design handle.
(m) The user can grip the handle quicker through the 90 degree horizontal frame.
(n) The painter has a better center of gravity through the alternative 45 degree offset vertical handle. This will give the painter better control movement up or down the step ladder.
(o) The homeowner can move the can of paint or utility bucket easier from step to step on a step ladder.
(p) The tradesperson has better balance using a 5 gallon bucket on a step ladder.
(q) The user has better stability with a 5 gallon bucket through means of the closed grip design handle.
(r) The homeowner can increase productivity through means of the left side mount lower vertical hook.
(s) The painter can move different size gallon buckets through means of the left side mount lower rectangular vertical hook.
(t) The user can safely hang a bucket of tools, and a bucket of paint through means of the alternative left and right side vertical hooks.
(u) The homeowner has easy access to their bucket of tools through means of the side rail attachment.

### CONCLUSION, RAMIFICATIONS, AND SCOPE

The present invention is an innovative simple design solution, for attaching a can of paint or utility bucket to a step ladder. The emphasis of the invention is primarily directed toward addressing the key issues of the painter's productivity, ease of use and safety while painting on a step ladder. The easy-to-grip handle on our step ladder bucket hook makes this hook simple and unique. Furthermore, the painter can hold onto the step ladder safely with one hand, and move the can of paint or utility bucket with the other hand in a quick and safe manner.

Although the description of the present invention contains specifics of the preferred embodiment, these should not be construed as limiting the scope of the invention. The embodiment described herein is subject to variation in structure, design, and manufacturing methodology. For example, practical variable alternatives are presented herein for a handle grip.

Accordingly, the scope of the invention should be determined by the appended claims and their legal equivalents, and not be limited to the details disclosed herein.

We claim:

1. A paint bucket step ladder hook will attach to a step ladder, wherein said step ladder bucket hook has a strong solid ergonomic plastic ribbed style handle for hanging the step ladder hook to a step of a step ladder, comprising of:
(a) a strong rigid material shaped to form the upper hook embodied to the handle, thereby providing a means for the user to attach said step ladder bucket hook to either the left or right side of a step ladder step;
(b) a unique embodiment wherein said strong solid ergonomic plastic ribbed style handle is formed into said upper hook thereby providing a firm grip for a faster, safer and easier means of balanced maneuverability for the user while working on a step ladder;
(c) a bottom vertical hook is incorporated in the lower embodiment of the handle thereby providing a quick secure means of attachment for the user's can of paint or utility bucket.

2. The paint bucket step ladder hook of claim 1 wherein said strong solid ergonomic plastic ribbed handle includes a rounded, strong plastic or metal upper hook structured into the handle and offset style plastic or metal frame thereby providing a means for the user to have a safe and stabilized attachment to a step ladder.

3. The paint bucket step ladder hook of claim 2 wherein said strong solid ergonomic plastic ribbed handle will embody a strong plastic or metal frame, wherein said frame has a unique offset at the center of the frame, providing a means of better balance, stability and safety when the user attaches the paint bucket step ladder hook to a step ladder at high elevations.

4. The paint bucket step ladder hook of claim 3 wherein said strong plastic or metal frame with unique center offset incorporates a horizontal hook attachment to the step ladder step, thereby creating a locking action to the step ladder. The strong plastic or metal frame creates an embodiment forming the vertical handle followed by a lower vertical hook, thereby providing a means of a safe and secure attachment for a bucket of paint or utility bucket.
